(19) United States
(12) Patent Application Publication
(10) Pub. No.: US 2016/0162935 A1
(43) Pub. Date: Jun. 9, 2016

(54) REMARKETING BASED ON CUSTOMIZED CONSUMPTION INTERVALS

(71) Applicant: Facebook, Inc., Menlo Park, CA (US)

(72) Inventors: Lee Charles Linden, San Francisco, CA (US); Benjamin Lewis, San Francisco, CA (US); Dwight Ewing Crow, San Francisco, CA (US)

(21) Appl. No.: 14/563,743

(22) Filed: Dec. 8, 2014

(51) Int. Cl. G06Q 30/02; G06Q 50/00; H04L 29/08

(52) U.S. Cl. CPC G06Q 30/0251; H04L 67/306; H04L 67/22; G06Q 30/0202; G06Q 50/01

(57) ABSTRACT

The present disclosure relates, in part, to systems and methods that provide for effectively remarketing a product to a user based on a customized consumption interval. In particular, a system can maintain a social networking profile associated with a user that includes personal information associated with the user. The system can further identify a purchase of a product and generate a customized consumption interval for the product based on the personal information associated with the user. Using the customized consumption interval, the system can more efficiently remarket a product to the user.

### BACKGROUND

1. Technical Field

One or more embodiments relate generally to remarketing products to users of an online social networking system. More specifically, one or more embodiments relate to providing social networking system users with targeted remarketing based on customized consumption intervals.

2. Background and Relevant Art

A social networking system allows its users to connect to and communicate with other social networking system users. Each user may create a profile on a social networking system that corresponds to a user identity and may include information about each specific user, such as interests and demographic information. Because of the increasing popularity of social networking systems, as well as the increasing amount of user-specific information to which a social networking system has access, a social networking system may provide an ideal forum for advertisers to increase awareness about products or services.

Generally, advertisers may include third-party merchants (e.g., entities separate from the provider of a social network system). Many merchants market their goods and/or services outside of a social networking system (e.g., by way of websites and/or mobile applications associated with the third-party merchants). However, a merchant may desire to advertise to users within a social networking system to drive more user traffic to the merchant's website. For example, presenting advertisements to users within a social networking system can allow a merchant to gain increased public awareness for and sales of its products.

Conventionally, a merchant can track an individual user's activity with respect to the merchant's website or mobile application, however, the merchant generally lacks any additional information about the user that would be helpful in advertising the merchant's products to the user, or to other potential customers, based on activity of an individual user. More often than not, a merchant's best opportunity to use an individual user's activity to trigger advertising is by sending a follow-up communication to the individual user, assuming the merchant has an email address or physical address for the user. Therefore, the merchant's advertising activities are often inefficient, limited in nature, and lack accurate targeting to customers.

Additionally, even where marketing a product successfully results in a user purchase of a product, the merchant generally lacks additional information that would be useful in continuing to market the product (or related products) to the user. For example, without additional information about the user, the merchant often makes assumptions regarding when to remarket a product to the user. To illustrate, the merchant may make assumptions as to how long it will take the user to consume a product without any knowledge of the user's personal circumstances that might affect the time it takes the user to consume the product. Thus, merchants often fail to remarket a product to a user efficiently or in a way that is customized to the user's individual situation.

Accordingly, there are a number of disadvantages with conventional methods of providing targeted advertising to users of a social network.

### SUMMARY

One or more embodiments described herein provide benefits and/or solve one or more of the foregoing or other problems in the art with systems and methods for more effectively remarketing a product to a user. In accordance with one or more embodiments, a social networking system can maintain a social networking profile associated with a user of a social networking system that includes personal information associated with the user. The social networking system can further identify a purchase of a product by the user and generate a customized consumption interval for the product based on the personal information associated with the user. Further, the social networking system can remarket the product or another product to the user based on the customized consumption interval. By so doing, the social networking system can remarket a product to the user in a way that accounts for the user's personal circumstances and more accurately predicts when the user will need to purchase the product again.

In some embodiments, a social networking system can remarket a product to a user based on personal information regarding relationships between social networking users. For example, using social networking profiles associated with users, the social networking system can identify how many people are living in a user's household (e.g., based on social networking connections between family members, such as between spouses and/or between parents and children). Using this information, the social networking system can generate a customized consumption interval that accounts for the number of people in the household, the ages of these people, the gender of these people, etc. Accordingly, the social networking system can more accurately predict when the user will need to buy a product again. Thus, the social networking system can efficiently remarket the product (or a related product) to the user at a time when the user is most likely to purchase the product again.

Additionally, the social networking system can dynamically update or modify the customized consumption interval as additional information becomes available. For example, the social networking system can recalculate or modify a customized consumption interval as additional personal information about a user or a related user is received by the social networking system. Additionally, the social networking system can update or modify the customized consumption interval as additional purchase information (e.g., a subsequent purchase of the product) is identified. As such, the social networking system can dynamically update or modify the customized consumption interval to more effectively remarket the product to the user in accordance with the most up-to-date information that might affect when the user will be interested in purchasing the product again.

Additional features and advantages of the embodiments will be set forth in the description that follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features of the disclosure can be obtained, a more particular description of the disclosure briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. In the following drawings, bracketed text and blocks with dashed borders (e.g., large dashes, small dashes, dot-dash, dots) are used herein to illustrate optional features or operations that add additional features to embodiments of the disclosure. Such notation, however, should not be taken to mean that these are the only options or optional operations, and/or that blocks with solid borders are not optional in certain embodiments of the disclosure. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates a schematic diagram of a system for remarketing a product to a user in accordance with one or more embodiments of the present disclosure;

FIG. 2 illustrates a block diagram of an example environment for implementing the system of FIG. 1 in accordance with one or more embodiments of the present disclosure;

FIG. 3 illustrates a block diagram of an example environment for implementing the system of FIG. 1 in accordance with one or more embodiments of the present disclosure;

FIG. 4 illustrates a flow diagram of a method of remarketing a product to a user in accordance with one or more embodiments of the present disclosure;

FIG. 5 illustrates a block diagram of an exemplary computing device in accordance with one or more embodiments of the present disclosure; and

FIG. 6 is an example network environment of a social networking system in accordance with one or more embodiments of the present disclosure.

### DETAILED DESCRIPTION

One or more embodiments of the present disclosure facilitate the effective remarketing of products to a user of a social networking system. In particular, one or more embodiments improve the timing of marketing products to a user based on a customized consumption interval. For instance, a social networking system can maintain a social networking profile associated with a user of a social networking system. The social networking profile can include personal information associated with the user. The social networking system can further identify a purchase of a product by the user and generate a customized consumption interval for the product based on the personal information in the social networking profile associated with the user. The social networking system can remarket the product or another product to the user based on the customized consumption interval.

For example, by generating a consumption interval that is customized for a social networking system user, the social networking system can remarket a product to the user when the user is most likely to need and/or desire to purchase the product again. In particular, the social networking system can identify a purchase of a product and generate a customized consumption interval for the product based on personal information associated with the user. For example, the social networking system can consider personal information about a user (e.g., age, family size, location, gender) to more accurately predict how long it will take the user to consume the purchased product. Thus, by accurately determining a customized consumption interval, the social networking system can provide an effective timetable for remarketing the product to the user.

Additionally, the social networking system can further increase the accuracy of the consumption interval by dynamically updating or modifying the consumption interval. In particular, the social networking system can consider additional information (e.g., personal information, purchase information) as it becomes available to the social networking system to more accurately predict when a user will again want or need to purchase a product. For example, the social networking system can receive additional personal information about a user (or related user) that affects the consumption interval and update or modify the consumption interval accordingly. In another example, the social networking system can identify a subsequent purchase of a product that affects the customized consumption interval and update or modify the consumption interval in accordance with the subsequent purchase. Thus, the social networking system can, for example, avoid unnecessarily remarketing a product to a user when the user has already purchased the product again.

As used herein, the term “marketing” refers to providing advertising content associated with one or more products. In some embodiments, a product may be marketed to a particular user over a communication network, on a third-party website or application, or by way of a social networking system. Additionally, the term “remarketing” refers to advertising or marketing a product or products to a user based on one or more products that the user has previously purchased or shopped for. For example, a system may remarket a product to a user if the user has purchased the product or a related product at an earlier date. Further, “remarketing” may refer to advertising or marketing a product to a user after the product has been previously marketed to the user.

As used herein, the term “consumption interval” refers to a period of time associated with the consumption of a good or completion of service. For example, a consumption interval can represent a time that it takes for a user to use up, finish, expend, or otherwise consume a product. In other words, a consumption interval can represent the time between a product purchase and when a user is likely to purchase the product again. In addition, a consumption interval may represent a contract term associated with a product. For example, a consumption interval may represent the number of years in a service agreement (e.g., a mobile phone services agreement) or a financing agreement (e.g., a loan agreement) associated with a product. The consumption interval can be based on the actual time to consume a product, or some time (e.g., a predetermined time period) short of consuming the product. In some embodiments, the consumption interval can include a prediction of time based on an expected consumption rate of the product by the user who purchased the product and/or other users associated with the user who purchased the product, as will be explained in more detail below.

Further, as used herein, the terms “product” and “products” refer to both goods and services. For example, a product can refer to a tangible good, an intangible good, or a service.

As used herein, the term “content” refers to any form of digital data that may be transmitted over a communication network. For example, content can include, but is not limited to, web sites, web pages, digital media (e.g., audio, video, images), electronic documents, electronic communication messages, or any other digital content or combination of digital content. In addition, the term “third-party content” refers to content that is provided by a content source that is outside of a social networking system. As another example, “marketing content” can refer to any content provided to a user for advertising one or more products.

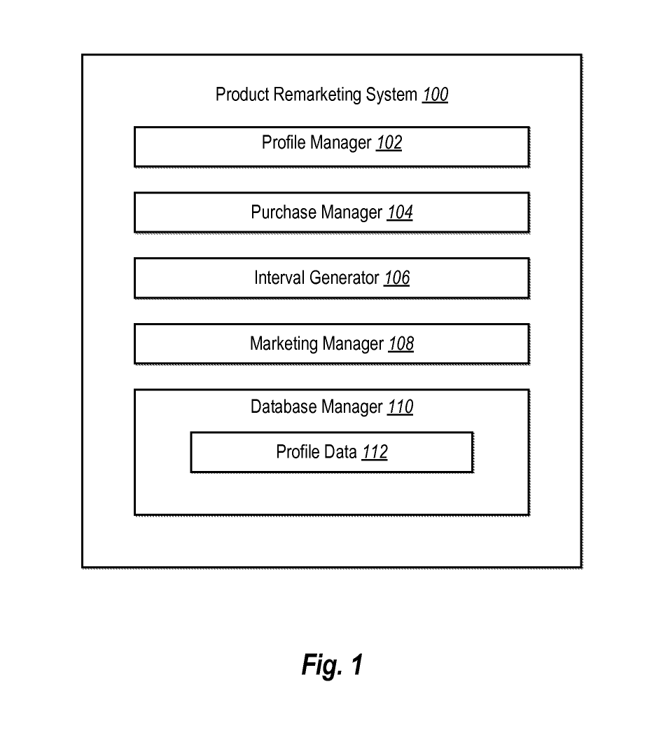

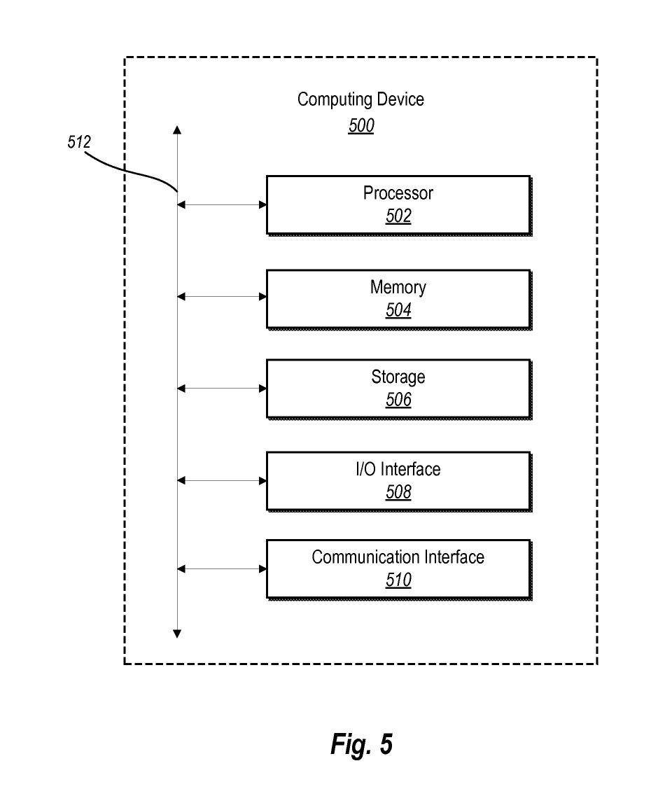

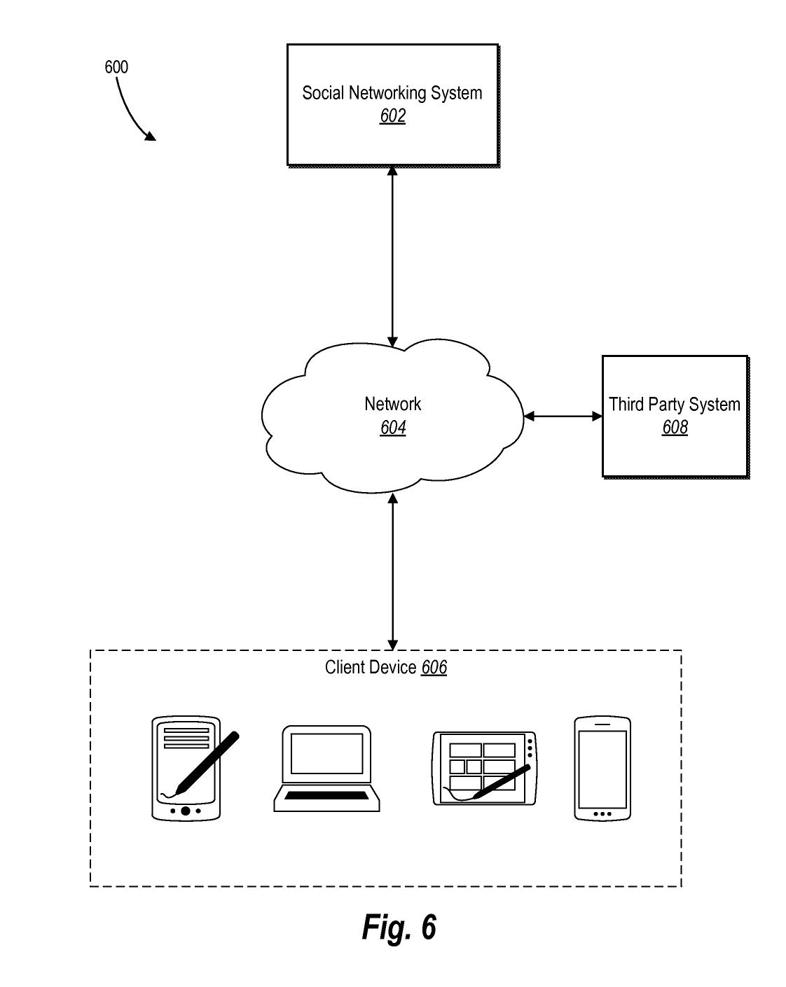

FIG. 1 illustrates an example embodiment of a product remarketing system 100 (or simply “system”) in accordance with one or more principles described herein. In some embodiments, the system 100 may be implemented within a social networking system, as discussed in more detail below. As shown, the system 100 includes a profile manager 102, a product manager 104, an interval generator 106, a marketing manager 108, and a database manager 110. Each of the components 102-110 of the system 100 may be in communication with one another using any suitable communication technologies. It will be recognized that components 102-110 can be combined into fewer components, such as into a single component, or divided into more components as may serve a particular embodiment. Additionally, components 102-110 can be located on, or implemented by, one or more computing devices, such as those described below in relation to FIG. 5. Alternatively, portions of the system 100 can be implemented on a client device, while other portions of the system 100 can be implemented on a social networking system, such as described below in reference to FIG. 6.

The components 102-110 can include software, hardware, or a combination thereof. For example, the components 102-110 can include one or more instructions stored on a computer-readable storage medium and executable by one or more processors of one or more computing devices. When executed by the one or more processors, the computer-executable instructions of the system 100 can cause a computing device to perform the methods described herein. Alternatively, the components 102-110 can comprise hardware, such as a special purpose processing device to perform a certain function or group of functions. Additionally or alternatively, the components 102-110 can include a combination of computer-executable instructions and hardware.

As mentioned above, and as shown in FIG. 1, the system 100 can include a profile manager 102. The profile manager 102 can manage information associated with one or more users. In particular, the profile manager 102 can maintain a social networking profile including profile information associated with a user of a social networking system. In some embodiments, the profile manager 102 can maintain profiles of many social networking user profiles, including profile information associated with each user and/or subscriber of the system 100.

In one or more embodiments, the profile manager 102 can manage various types of profile information associated with one or more users and/or subscribers of the system 100. For example, profile information managed by profile manager 102 can include personal information, social networking information, and/or purchase information. In some examples, the personal information and/or social networking information can include information about related users of a social networking system associated with a particular user. In some embodiments, profile information is maintained on the system 100. Alternatively, profile information can be maintained on one or more devices external to the system and accessible to the profile manager 102.

As mentioned above, profile information can include personal information associated with a user. In particular, personal information can include any information that is descriptive of a user of a social networking system. Examples of personal information may include demographic information (e.g., age, race, gender), location information (e.g., country, state, city, residence, place of work), profession, income, family size, household size, religious affiliations, relationship status, physical characteristics, education, birthday, or any other information that is personal to the user. In some embodiments, a user can provide personal information upon registering with a social networking system. Additionally or alternatively, the profile manager 102 may gather personal information associated with a user over time and/or subsequent to the user registering with the social networking system.

In some embodiments, the profile manager 102 can derive personal information about a user from one or more users associated with the user. In particular, the profile manager 102 can utilize the personal information to derive information associated with another user associated with the user. For example, the profile manager 102 can utilize the personal information to identify a family member (e.g., a spouse) of the user, a roommate of the user, a close friend of the user, or any other related user. The profile manager 102 can also identify personal information associated with any such related users. For instance, identified relationships and information about the related users can provide information about demographics, location, household income, family size, household size, or other personal information descriptive of the user that may affect a user's consumption of products, as will be described in more detail below.

In addition to the foregoing, the profile manager 102 can utilize social networking information associated with a user. In particular, social networking information can include information related to activity of a user on the social networking system 100. For example, social networking information can include social networking activity data, such as social networking content views, comments, “likes,” links clicked on, social networking pages visited, games played, location check-ins, posts (including texts, pictures, messages, and videos), and/or any other social networking activity. In some embodiments, social networking information can further include information about a user's social network, such as relationships (e.g., friends, co-workers, related users), newsfeed content, current geographic locations, groups, and other information about a user's social network. Additionally or alternatively, social networking information can include information related to activities performed by one or more users associated with the particular user.

Additionally, the profile manager 102 can manage and/or utilize purchase information associated with a user. In particular, the profile information associated with a user can include a history or record of purchases made by the user. For example, the purchase information can include a record of purchases made by a user or related user using the social networking system. Alternatively, purchase information can include a record of identified purchases using other systems (e.g., a third party commerce system).

As mentioned above, the system 100 can further include a purchase manager 104 that identifies one or more purchases of a product by a user. In particular, the purchase manager 104 can identify a purchase of a product, including information associated with the purchase of the product. For example, the purchase manager 104 can identify the product, the date of purchase, the price of the purchase, the quantity of the product purchased, and/or any other information associated with the purchase of the product by the user. In some embodiments, the purchase manager 104 can store and/or otherwise maintain the information associated the purchase (e.g., on a database).

In some embodiments, the purchase manager 104 can identify a purchase made by the user via the system 100. In particular, the purchase manager 104 can communicate with the system 100 to track one or more purchases made by the user using the system 100. For example, the system 100 can provide one or more applications to a user to purchase one or more products. Additionally, the system 100 can provide applications and/or interfaces for a user to purchase one or more products from particular vendors having the capability to sell products through the system 100. Alternatively, the system 100 can receive information from one or more third-party merchants about products purchased by a user through a third-party system (e.g., website or mobile application).

As mentioned above, the system 100 can further include an interval generator 106. The interval generator 106 can generate and/or customize a consumption interval for a product purchased by a user. The customized consumption interval can represent an estimation of how long it will take a user to “consume” (e.g., use, finish, wear out, etc.) a product. For example, where the product manager 104 identifies a purchase of cereal, the interval generator 106 may generate a customized consumption interval that represents an estimation of how long it will take for the user to eat the cereal. Alternatively, in other examples, the customized consumption interval can represent a contract term or other length of time associated with the product.

The customized consumption interval can depend on the product or purchase of the product. In particular, the customized consumption interval can depend on one or more factors related to the product or purchase of the product. Examples of factors related to the product or purchase of the product affecting the customized consumption interval can include the quantity of the product purchased, the expiration date of the product, and/or the expected completion date of a service (e.g., where the product is a service). Additionally, a combination of these and other factors can affect the customized consumption interval for a product.

In some embodiments, the interval generator 106 can identify a default consumption interval associated with the product. In particular, the interval generator 106 can identify the default consumption interval for the product based on a predicted consumption interval of the product for a typical or average user. For example, without taking personal information into account, the interval generator 106 can associate a default consumption interval with a product, and generate a consumption interval for the product based on the default consumption interval.

In some embodiments, the interval generator 106 can generate a customized consumption interval based on personal information. As mentioned above, personal information can include profile information provided to or accessible to the system 100, such as demographic information, location information, and other information that is personal to a user. Thus, the interval generator 106 can generate or modify a consumption interval in view of any type of personal information that may affect the consumption interval for a product, thereby customizing the consumption interval for the user. Additionally, the interval generator 106 can consider additional types of information (e.g., social networking information, purchase information, information associated with related users) in generating or modifying the customized consumption interval.

As mentioned above, the system 100 can further include a marketing manager 108 for remarketing a product to a user based on a customized consumption interval. In particular, the marketing manager 108 can provide marketing content to the user at a time that coincides with when the user has consumed or nearly consumed the product. For example, the marketing manager 108 can remarket the product to the user upon completion of the customized consumption interval. Additionally or alternatively, the marketing manager 108 can remarket the product to the user prior to completion and/or near the end of the customized consumption interval.

In some embodiments, the marketing manager 108 can remarket the same product or similar product as a previously purchased product based on the customized consumption interval. As mentioned above, the marketing manager 108 can provide marketing content for the same product purchased by the user upon completion of the customized consumption interval. Alternatively, the marketing manager 108 can provide marketing content for a related product (e.g., different brand of the same type of product) upon completion of the customized consumption interval.

In remarketing the product to the user, the marketing manager 108 may facilitate communication of the marketing content to the user in a variety of ways. For example, the marketing manager 108 may communicate with the system 100 to provide marketing content to a user via a social networking system. For instance, the system 100 can provide marketing content via a message or a post to a newsfeed or inbox of the user. Further, the system 100 can communicate marketing content to a user by facilitating display of an advertisement or banner on a client device. The system 100 can further provide other types of electronic communications to a user including marketing content. In yet a further embodiment, the marketing manager 108 may automatically add the marketed product to the user's shopping cart upon completion of the consumption interval. Alternatively, the marketing manager 108 can communicate with the system 100 to facilitate delivery of other forms of marketing content, such advertisements through the mail to a user's address.

As discussed above, the system 100 can include a database manager 110, as illustrated in FIG. 1. The database manager 110 may maintain profile data 112 representative of profile information associated with a user. For example, the profile information data 112 can include data representative of, but not limited to: personal information, social networking information, activity information, relationship information, purchase information, and/or any other information associated with users of a social networking system.

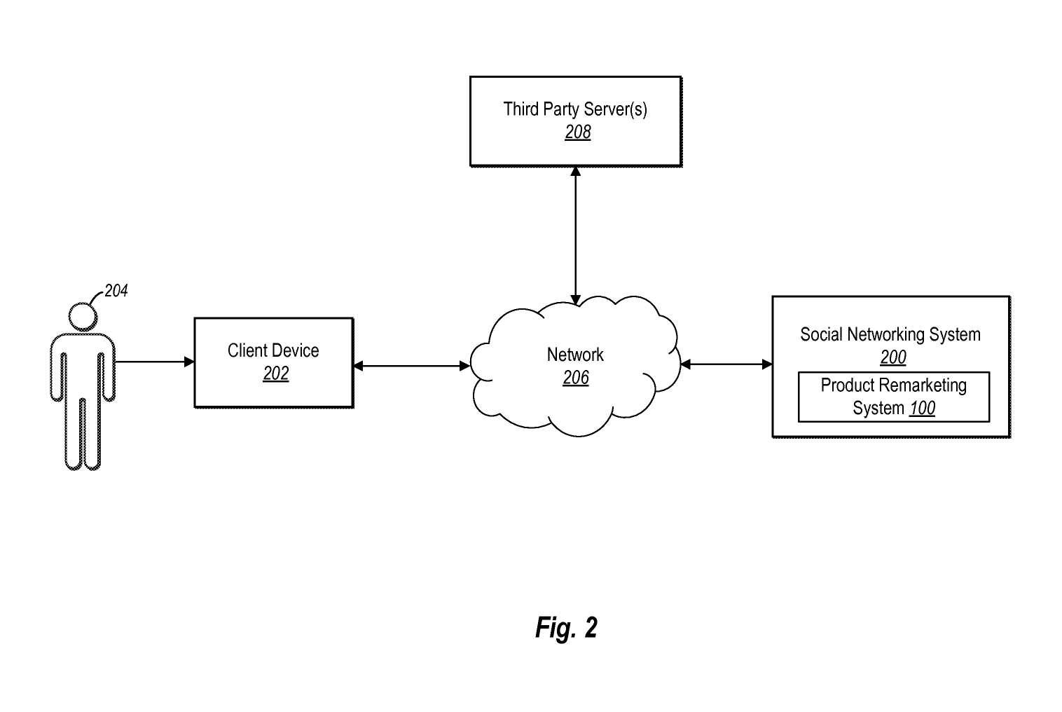

FIG. 2 illustrates a block diagram of an example environment for implementation of a product remarketing system 100. In particular, FIG. 2 illustrates a client device 202 associated with a user 204. The client device 202 may be in communication with a social networking system 200 by way of a network 206. Further, each of the client device 202 and the social networking system 200 can communicate with a third-party server 208 by way of the network 206 and/or one or more additional networks.

In some embodiments, functions and features described herein can be performed entirely on the social networking system 200. For example, the system 100 may be implemented within the social networking system 200. Alternatively, the client device 202 can perform one or more of the functions described with respect to the system 100. In some embodiments, the social networking system 200 and the client device 202 can perform a combination of different functions described herein.

As illustrated in FIG. 2, the user 204 can communicate with the social networking system 200 by way of the client device 202. The user 204 can be an individual (e.g., human user), a business, a group, or other entity. Although FIG. 2 illustrates only one user 204, it is understood that multiple users can communicate with the social networking system 200 through a corresponding plurality of client devices. Further, the client device 202 can include various types of computing devices. For example, the client device 202 can include a mobile device such as a mobile telephone, a smartphone, a PDA, a tablet, a laptop, or a non-mobile device such as a desktop, server, or other computing device. Additional details with respect to the client device 202 are discussed below with respect to FIG. 5.

In some embodiments, a user 204 can provide profile information to the social networking system 200. In particular, the user 204 can provide personal information to the social networking system 200 by way of the client device 202. For example, the user 204 can provide personal information to the social networking system 200 when registering with the social networking system 200 and/or creating or editing a user profile associated with the user 204 on the social networking system 200. In some embodiments, the social networking system 200 can obtain profile information or other personal information by accessing information accessible to the social networking system 200 on the client device 202.

In addition to personal information, the social networking system 200 can obtain social networking information associated with the user based on activity of the user 204 on the client device 202. In particular, the user 204 may interact with the social networking system 200 using the client device 202. For example, a user 204 can interact with the social networking system 200 in various ways, such as posting messages/updates, viewing social networking content (e.g., posts, pictures, messages), interacting with content (e.g., “like” or “comment” with respect to social networking content), searching content, clicking on advertisements, etc.

In addition to communicating with the social networking system 200, the user 204 can interact with the client device 202 to communicate with one or more third-party servers. For example, as illustrated in FIG. 2, the user 204 can use the client device 202 to receive and/or provide content to a third-party server 208. Additionally, the social networking system 200 can access and/or receive content from the third-party server 208 to collect additional profile information (e.g., personal information) associated with the user 204.

The system 100 can maintain a social networking profile associated with a user 204 of the social networking system 200. In particular, the system 100 can maintain a social networking profile including personal information, social networking information, purchase information, and other information and provide access to any information associated with the user 204 to the social networking system 200. In some embodiments, system 100 can store and/or maintain the profile information on a database accessible to the social networking system 200.

The system 100 can use a variety of methods in obtaining and/or maintaining the profile information. For example, the social networking system 200 can receive personal information from a user 204 by way of a client device 202. In particular, the user 204 can explicitly provide personal information to the social networking system 200 using the client device 202. For example, the user 204 can provide personal information to the social networking system 200 when registering for the social networking system 200 and/or editing a user profile associated with the user 204. Additionally, as the user 204 adds friends, family, and indicates additional users and respective relationships between the user 204 and other users, the social networking system 200 can continue to derive personal information associated with the user 204.

In addition to receiving profile information from the user 204, the social networking system 200 can receive profile information and/or access information associated with a user from the third-party server 208. In particular, where the user 204 provides personal information to a third-party server 208 that is accessible to the social networking system 200, the social networking system 200 can receive the personal information provided to the third-party server 208 by the user 204 via the client device 202. Additionally or alternatively, the social networking system 200 can access the third-party server 208 without necessarily receiving personal information from the user 204 and/or third-party server 208.

In addition to receiving information and/or accessing information from the third-party server 208, in some embodiments, the system 100 can access a client device 202 associated with the user 204. For example, where the user 204 has provided access to the social networking system 200 to the client device 202, the system 100 can access one or more files on the client device 202 to further obtain profile information associated with the user 204. In some embodiments, the system 100 can obtain the profile information using, for example, a tracking element. Alternatively, the system 100 may obtain the profile information based on permission granted to the social networking system 200 by the user 204.

The system 100 can identify a purchase of a user 204 using the client device 202. In particular, the system 100 can identify information associated with a purchase made by the user 204 using the client device 202. For example, the system 100 can identify information, including, but not limited to, price, quantity, date, or other data related to the purchase by the user 204. The system 100 can further identify additional information, such as the brand of the product, merchant of the product, or the website on which the user 204 made the purchase. In some embodiments, the system 100 can store the identified purchase information for later access by the social networking system 200.

In some embodiments, the system 100 can communicate with one or more third-party servers to identify a purchase made by a user 204 using the third-party servers. For example, the third-party server 208 can provide third-party content to the social networking system 200 by way of a third-party website through which the user 204 purchases the product using the client device 202. In some embodiments, the third-party server 208 can provide an interface through which the user 204 purchases a product from the merchant or third-party website through the social networking system 200. Alternatively, a third-party server 208 can provide purchase information to the social networking system 200 for a product bought through the third-party website using the client device 202.

In addition to receiving purchasing information from the third-party server 208, the system 100 can further identify a purchase by a user 204 by monitoring activity of a user 204 on a third-party website using the client device 202. In particular, rather than receiving information directly from a third-party server 208, the system 100 can utilize one or more tracking elements implemented on the client device 202 that facilitate identifying a purchase made by a user 204 by way of a third-party website. For example, a tracking element may track pixels (e.g., a JavaScript or another piece of software code) on a client device 202 that causes third-party content to be provided to the social networking system 200 by way of the client device 202. In some embodiments, the system 100 can utilize a tracking element on the client device 202 in addition to receiving information from a third-party server 208 in identifying a purchase of a product by a user 204. Alternatively, the system 100 can identify a purchase using only a tracking element on the client device 202 rather than obtaining purchasing information through the user 204 interacting with the social networking system 200.

Upon identifying a purchase of the product by the user 204, the system 100 can generate a customized consumption interval for the product based on personal information associated with the user 204. In particular the system 100 can estimate when a product will be consumed or nearly consumed by the user 204 based on the personal information. In this way, the system 100 can determine when or how to remarket the product to the user 204 when the user 204 is likely to purchase the product again.

The system 100 can generate a customized consumption interval in a variety of ways. For example, in one embodiment, the system 100 can identify a default consumption interval associated with a product and generate a customized consumption interval by modifying the default consumption interval. In particular, the system 100 can identify or otherwise determine a default consumption interval for a product that represents an estimated period of time that an average user will take to consume the product purchased by the user 204, without necessarily considering personal information associated with the user 204.

Upon identifying the default consumption interval, the system 100 can generate a customized consumption interval by modifying the default consumption interval based on personal information associated with the purchasing user (e.g., user 204). In particular, the system 100 can lengthen or shorten the default consumption interval by considering personal information about the purchasing user accessible to the social networking system 200. As an example, the system 100 can consider personal information, such as family size, in modifying the default consumption interval. For example, a user 204 having a larger family would likely consume a product faster than a user 204 having a smaller family. Accordingly, the system can decrease the consumption interval for each additional member of the family.

In some embodiments, the system 100 can consider one or multiple types of personal information in generating or modifying the consumption interval. For example, as described above, the system 100 can consider a single type of personal information (e.g., family size) to modify a default consumption interval. Alternatively, the system 100 can consider one or more additional types of personal information (e.g., demographic information, location information, relationship status, physical characteristics, education, family size, household size, household income, personal income, birthday) in generating or otherwise modifying a consumption interval.

As mentioned above, in generating a customized consumption interval using a default consumption interval, the system 100 can consider personal information, such as the age and family size of a user 204 in modifying the default consumption interval. As an example, based on personal information associated with a user 204, the system 100 can determine that a user 204 (male, age 40) lives with a spouse (female, age 40) and has one male child (age 8) and one female child (age 14). Where the user 204 has bought one large package of toilet paper, the system 100 can determine that a default consumption interval for a typical user of the package of toilet paper is equal to one month. Based on the personal information indicating that three additional people live with the user 204 and are likely to participate in consumption of the toilet paper, the system 100 may modify the default consumption interval to equal one week or one fourth of a month.

In a similar example including the user 204, spouse, and two children, the system 100 can identify a purchase by the user 204 (or spouse) of a certain quantity of makeup. The system 100 may also identify a default consumption interval of four months associated with the quantity of makeup. In addition to considering the household size, the system 100 can further consider the age and gender of people in the user's 204 household. For example, the system 100 may determine that the user 204 and son are unlikely to participate in the consumption of the makeup and therefore determine that only two users (i.e., the two female users of age consistent with the user of makeup) in the user's 204 household will participate in the consumption of the makeup. Based on this personal information associated with the user 204 and family, the system 100 may modify the default consumption interval to equal two months.

As an alternative to determining and/or identifying a default consumption interval, the system 100 can generate a customized consumption interval by implementing a formula that is a function of one or more types of personal information. In particular, the system 100 can process a function having multiple variables corresponding to types of personal information. For example, the system 100 can incorporate each of the known types of personal information that affect a consumption interval for a product and calculate a customized consumption interval based on each of different types of personal information. Further, each of the types of personal information may modify the calculated value of the customized consumption interval. For example, one or more types of personal information may provide a factor that increases or decreases the customized consumption interval. For instance, a first type of personal information may increase the customized consumption interval for a product by a predetermined percentage or amount while a second type of personal information may decrease the customized consumption interval by a predetermined percentage or amount.

To illustrate, the system 100 may apply different multipliers associated with specific aspects of personal information associated with the user 204 in determining the customized consumption interval. For example, each aspect of personal information that may affect a consumption interval may be associated with a multiplier that represents the effect of the aspect of personal information on the time it takes to consume a corresponding product. In some embodiments, applying a multiplier to the consumption interval may reduce the consumption interval (e.g., if the corresponding aspect of personal information is determined to reduce the time it will take to consume the product). Alternatively, applying a multiplier to a consumption interval may increase the consumption interval (e.g., if the aspect of personal information is associated with an expected increase in the amount of time it will take to consume the product).

To illustrate, system 100 may identify a default consumption interval that is associated with the average amount of time expected to consume a product. The default consumption interval may be based on certain assumptions regarding an average user. The multipliers associated with each specific aspect of personal information may account for the differences between the user 204 and the average user associated with the default consumption interval. As one illustrative example, if a user purchases a canister of protein supplements, the system 100 may identify a default consumption interval associated with the purchased canister of protein supplements. The system 100 may then identify various aspects of personal information associated with the user that may effect the user's consumption of the purchased canister of protein supplements. For example, the system 100 may identify how frequently the user works out (e.g., based on the frequency that the user checks in at gyms using the system 100). Additionally or alternatively, the system 100 may identify how interested the user is in working out based on what pages or other content the user accesses via the system 100 and/or “likes” provided via the system 100. If the system 100 determines that the user works out more than an average user and/or is more interested in fitness than the average user, the system 100 may identify apply one or more corresponding multipliers to the default consumption interval that reduces the consumption interval (e.g., multipliers less than 1) to account for the likelihood that the user will consume the canister of protein supplements faster than the average user. If the system 100 determines that the user works out less than average and/or is less interested in fitness than the average user, the system 100 may apply one or more corresponding multipliers to the default consumption interval that increase the consumption interval (e.g., multipliers greater than 1) to account for the likelihood that the user will consume the canister of protein supplements more slowly than the average user.

If the system 100 identifies other users in the user's household that are likely to share the canister of protein supplements (e.g., adults in the house that also work out, as opposed to any children or other users in the household that don't work out or for which the product is not age appropriate) the system 100 can apply a multiplier to the consumption interval to account for the fact that multiple users will be sharing the product. For example, the system 100 can apply a 0.5 multiplier to the consumption interval to represent a determination that two users will be sharing the product and that it will likely take half the time to consume the product. In additional or alternative embodiments, the customization of the consumption interval may also take into account personal information associated with the users with which the primary user will be sharing the product.

To further illustrate, in the example including a user 204 (age 40) having a spouse (age 40) and two children (ages 14 and 8), the system 100 can apply a formula to determine a customized consumption interval for a product purchased by the user 204. For example, where a user purchases bottled water, the system 100 can apply a formula that accounts for characteristics of the user 204 and each member of the user's family. In particular, two adults and a teenager may be expected to each consume 32 ounces of the water purchased by the user 204 per day. Further, a child at age eight may be expected to consume one-half the amount of water per day as a typical adult. Thus, based on a prediction that the user 204, spouse, and two children will drink 112 (32+32+32+16) ounces of water per day, the system 100 can generate a customized consumption interval predicting when the bottled water will be consumed.

In another embodiment of generating a customized consumption interval, the system 100 can access a table or other collection of indexed data to determine a customized consumption interval associated with a product and/or one or more factors (e.g. multipliers) for customizing the consumption interval based on corresponding aspects of personal information. In particular, generating a customized consumption interval can include looking up a consumption interval value on a table that maps one or more different types of personal information to values associated with a consumption interval of the product. For example, the social networking system 200 can identify a cell within a table associated with a user 204 of a certain age, having a certain size of household, located in a particular geographic location, and/or with a particular square footage range that maps to a corresponding consumption interval for a product.

To illustrate, in an example of a user 204 (age 40) having a spouse (age 40) and two children (ages 14 and 8) living in a 2000 square foot house, the social networking system 200 may identify a purchase of a certain quantity of light bulbs by a user 204. In generating a customized consumption interval for the purchased quantity of light bulbs, the system 100 can lookup a consumption interval in an entry on a table that corresponds to a quantity of light bulbs for a family of four living in a 2000 square foot house to determine when the user 204 is expected to complete consumption of the purchased light bulbs and/or have a need to purchase additional light bulbs at a future date.

Furthermore, in generating the customized consumption interval for the product, the system 100 can consider information associated with one or more users from one or more sources other than the social networking system 200. For instance, where personal information includes an address of a user 204, the social networking system 200 can communicate with a third-party server 208 and access additional information related to the address of the user 204. For example, where a third-party server 208 is associated with a web site that can provide information such as the square footage, lot size, and/or property value corresponding to the address of the user 204, the system 100 can consider the additional information from the third-party server 208 in generating the customized consumption interval for the product purchased by the user 204.

To illustrate, in an example including a user 204 that purchases a quantity of lawn fertilizer where personal information associated with the user includes an address, the system 100 can access additional information associated with the user 204 from one or more sources other than the social networking system 200 when generating the customized consumption interval for the lawn fertilizer. In particular, the system 100 can access a web site and/or third-party server 208 that provides information such as square footage, lot size, and/or property value corresponding to the address of the user 204. Using this information, the system 100 can access and/or estimate a predicted period of time by which the lawn fertilizer will be consumed or nearly consumed. For example, based on a climate of the user's geographic location (as determined by the address) and/or based on the lot size obtained from the third-party server 208, the system 100 can predict a period of time during which the user 204 will consume the lawn fertilizer and generate a customized consumption interval for the lawn fertilizer purchased by the user 204.

In some embodiments, the system 100 can consider additional information (e.g., usage parameters) provided by a merchant. For instance, in the example of the lawn fertilizer, the system 100 may consider usage parameters for applying the fertilizer per square foot. For example, the lawn fertilizer can include usage parameters indicating how much fertilizer to apply per square foot in addition to a recommended frequency of application. The system 100 can factor these usage parameters into an equation including the projected square footage, lot size, and/or property value associated with the user 204 in generating the customized consumption interval.

In some embodiments, the system 100 can consider other information in addition to personal information to generate a customized consumption interval for the product. For example, the system 100 can consider social networking information (e.g., content viewed, “likes,” location check-ins, posts, newsfeed content, current geographic locations, groups) that may affect the consumption of a purchased product by the user 204. For instance, where a user 204 performs a check-in function or otherwise provides an indication that the user 204 is on vacation or not at home, the system 100 may determine that the user 204 will not consume one or more products while on the vacation. As an example, where the user 204 purchases a quantity of toilet paper, and the system 100 generates a customized consumption interval of four weeks for the toilet paper, the system 100 may lengthen the customized consumption interval to reflect the period of time that the user 204 is on vacation.

Using the customized consumption interval, the system 100 can remarket the product to the user 204. In particular, the system 100 can provide marketing content for the product to the user at a time prior to or upon consumption of a product previously purchased by the user. In this way, the user may receive remarketing content from the social networking system 200 at a time when the user is likely to buy the product or a similar product again because the product is nearly or completely consumed at the time the remarketing content is delivered to the user. In some embodiments, the system 100 can remarket the product to the user before the customized consumption interval expires. Alternatively, the system 100 can remarket the product to the user 204 upon or after expiration of the customized consumption interval.

In some embodiments, the system 100 can remarket a product similar to the product purchased product to the user 204 based on the customized consumption interval. In particular, the system 100 can remarket the same product from a different merchant or having a different brand from the product originally purchased by the user 204. For example, where a user 204 purchases a first product from a first merchant, the system 100 can remarket a second product from a second merchant that is similar or related to the first product (e.g., a substitute or complementary product). In some embodiments, the second product can be associated with the same merchant as the first product or, alternatively, a competing merchant.

In some embodiments, rather than remarketing the same product or same type of product to a user 204, the system 100 can remarket a related product to the user 204 based on the customized consumption interval for the product purchased by the user 204. In particular, the system 100 can remarket a related product (e.g., complementary product) other than the purchased product based on a prediction that the user 204 will be likely to buy the related product upon or near completion of the customized consumption interval. For example, where the system 100 identifies a purchase of a pen by the user 204, the system 100 may remarket a pen refill to the user 204 based on a customized consumption interval for the pen. Additionally, where personal information indicates that the user 204 is a student and/or has a profession that corresponds to frequently using the purchased pen, the customized consumption interval can reflect the personal information associated with the user 204 who purchased the pen.

In addition to remarketing the product or a related product to the user 204 based on the customized consumption interval, the system 100 can further remarket a product to a user in view of one or more subsequent purchases related to the product. For example, where a user 204 purchases the product or a similar product before expiration of the customized consumption interval, the system 100 can identify the subsequent purchase and modify the customized consumption interval based on the identified subsequent purchase. The system 100 may then remarket the product to the user 204 based on the modified consumption interval.

In an example, a user 204 having a spouse may purchase a box of toothpaste. As described above, the system 100 can generate a customized consumption interval for the box of toothpaste based on personal information associated with the user 204. Where the user 204 or spouse subsequently purchases a tube of toothpaste (e.g., upon or prior to consuming the box of toothpaste), the system 100 can identify the subsequent purchase and modify or lengthen the customized consumption interval in accordance with the subsequent purchase and remarket toothpaste to the user 204 based on the modified consumption interval. For example, the system 100 can lengthen the customized consumption interval to predict when the user 204 and spouse will complete consumption of the original purchase of toothpaste in addition to the subsequent purchase of toothpaste (e.g., assuming the user 204 purchased additional toothpaste prior to consuming the box of toothpaste). Alternatively, the system 100 can determine that the user 204 and spouse will complete consumption of the toothpaste faster than originally predicted and generate a customized consumption interval based on a revised estimation of when the user 204 will complete consumption of the toothpaste.

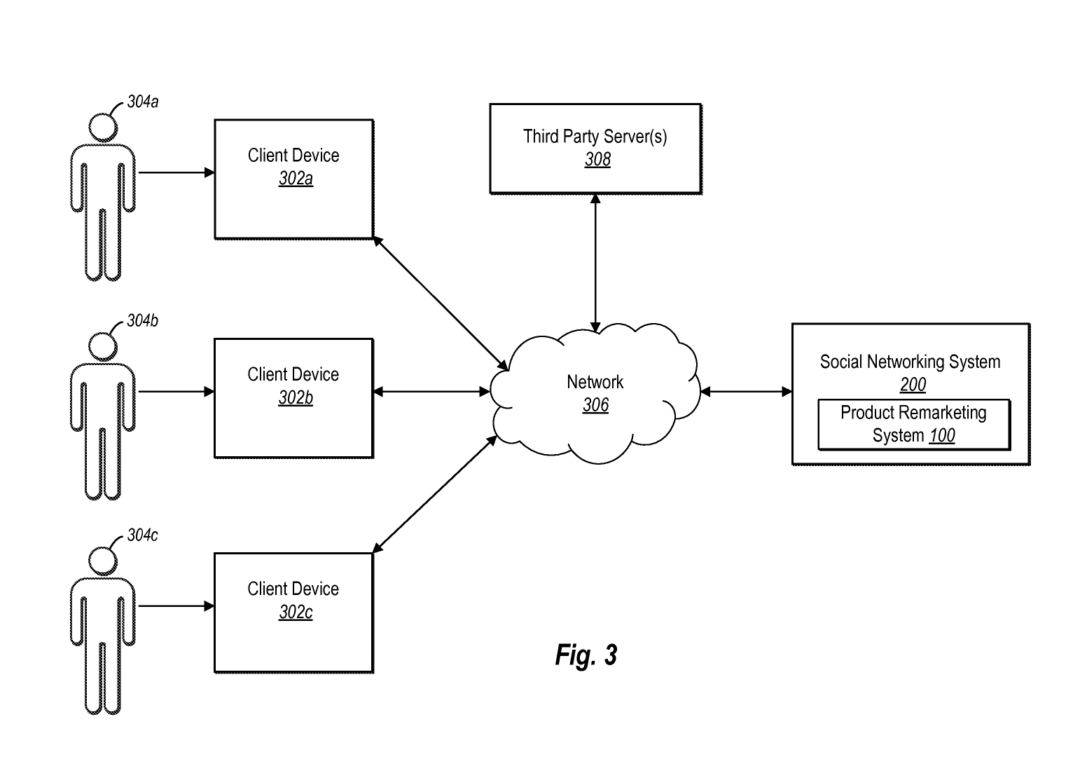

FIG. 3 illustrates a more detailed example environment for implementation of the product remarketing system 100. In particular, FIG. 3 illustrates multiple client devices 302a-c (referred to collectively herein as “client devices 302”) associated with respective users 304a-c (referred collectively herein as “users 304”). The client devices 302 may be in communication with a social networking system 300 by way of a network 306. Further, each of the client devices 302 and the social networking system 300 can communicate with one or more third-party servers 308 by way of the network 306 and/or one or more additional networks. Each of the social networking system 300, client devices 304, network 306, and third-party server 308 may have similar features and functionality as the social networking system 200, client device 202, network 206, and third-party server 208 described above in connection with FIG. 2. Additionally, similar to the illustrated embodiment of FIG. 2, the system 100 may be implemented within the social networking system 300.

In some embodiments, each user 304a-c can communicate with the social networking system 300 using a respective client device 302a-c. For example, a first user 304a (e.g., a primary user) can communicate with the social networking system 300 using a first client device 302a, a second user 304b can communicate with the social networking system 300 using a second client device 302b, and a third user 304c can communicate with the social networking system 300 using a third client device 302c.

In some embodiments, the system 100 can designate one user 304 as a primary user and one or more users associated with the primary user as related users. For example, the system 100 may recognize a first user 304a as a primary user and recognize and/or otherwise identify the second user 304b and the third user 304 as related users associated with the first user 304a. In particular, the system 100 can designate, recognize, or otherwise identify a relationship between the primary user 304a and one or more related users 304b-c associated with the primary user 304a. As an example, the related users 304b-c can be family members, roommates, friends, contacts, or have another association with the primary user 304a. In some embodiments, the personal information associated with the first user 304a can identify one or more related users 304b-c to the primary user 304a. Alternatively, the social networking system 300 can use different criteria in associating the primary user 304a and related users 304b-c.

As mentioned above, the system 100 can identify a purchase of a product by a user 304a. In some embodiments, identifying a purchase by a user 304a can include identifying a purchase of a product by the primary user 304a. Additionally or alternatively, the system 100 can identify a purchase of a product by one or more related users 304b-c associated with the primary user 304a. In some embodiments, the system 100 can identify both purchases of a product by the primary user 304a in addition to purchases of a product by one or more related users 304b-c.

As an example, where a primary user 304a lives with a spouse and where each of the primary user 304a and the spouse are users 304 of the social networking system 300, the system 100 can recognize (e.g., using personal information associated with the users 304) that the spouse is associated with the primary user 304a. In this example, if the primary user 304a purchases a box of cereal, the system 100 may identify that purchase of the cereal by the primary user 304a as a purchase by the primary user 304a. Additionally, if the spouse purchases a box of cereal, the system 100 may identify that purchase of the cereal by the spouse as a purchase by a related user associated with the primary user 304a.

In addition to identifying purchases of products by a primary user 304a and/or one or more related users 304b-c, the system 100 can generate a customized consumption interval for a product based on personal information associated with the primary user 304a. In some embodiments, the system 100 can include personal information associated with related users 304b-c in generating the customized consumption interval for the product. For example, where the primary user 304a is associated with a first related user 304b and a second related user 304c, the system 100 can consider purchases made by the primary user 304a and the related users 304b-c in generating the customized consumption interval. Alternatively, in some embodiments, the system 100 can disregard purchases made by the related users 304b-c when considering the customized consumption interval for a product purchased by the primary user 304a.

As an example, where personal information associated with a primary user 304a indicates that the primary user 304a lives with a spouse who is also a user of the social networking system 300, the system 100 can predict that the primary user 304a and the spouse will each participate in the consumption of different products purchased by either the primary user 304a or the spouse. For instance, in an example where the primary user 304a purchases garbage bags, the system 100 can determine that the primary user 304a and the spouse are likely to share in consumption of the garbage bags purchased by the primary user 304a and generate the customized consumption interval based on the reduced period of time that it will take for both the primary user and spouse to consume the product. Additionally, where the system 100 identifies that the spouse has purchased additional garbage bags (e.g., prior to completion of the customized consumption interval), the system 100 can generate a longer customized consumption interval and/or modify an existing consumption interval based on a predicted consumption of the additional garbage bags by the primary user 304a and the spouse.

Using the customized consumption interval, the system 100 can remarket the product to the user 304. In particular, the system 100 can remarket the product to the primary user 304a based on the customized consumption interval for the product purchased by the primary user 304a and/or related users 304b-c associated with the primary user 304a. In some embodiments, the system 100 can remarket the product to the primary user 304a and one or more related users 304b-c based on the personal information associated with the primary user 304a and related users 304b-c. Alternatively, the system 100 can limit the remarketing to the primary user 304a without also remarketing the product to the related users 304b-c.

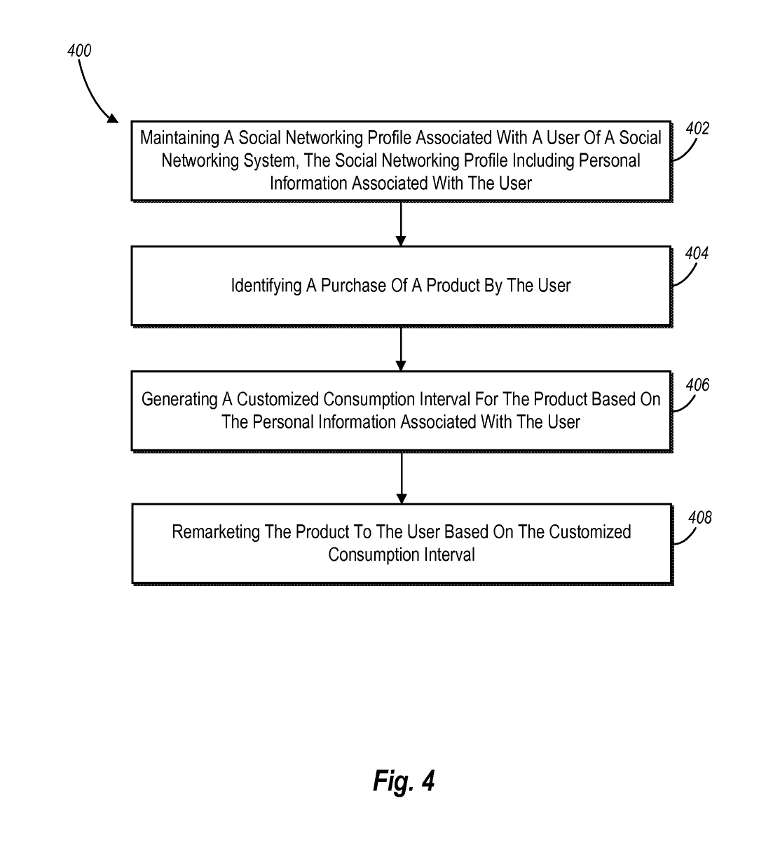

FIG. 4 illustrates a flowchart of an exemplary method 400 for effectively remarketing a product to a user. While FIG. 4 illustrates example steps according to one embodiment, other embodiments may omit, add to, reorder, and/or modify any of the steps shown in FIG. 4. One or more steps shown in FIG. 4 may be performed by any of the components illustrated in the product remarketing system 100 illustrated in FIG. 1. Further, one or more steps of the method 400 can be performed by a client device 202, social networking system 200, or a combination of both.

As illustrated in FIG. 4, the method 400 includes step 402, which may include maintaining a social networking profile associated with a user 204 of a social networking system 200. The social networking system 200 can include personal information associated with the user 204. For example, the profile manager 102 of the system 100 can maintain, using a processor, a social networking profile associated with a user 204 of the social networking system, where the personal information includes information associated with the user.

As described above, the personal information can include one or more of a location, age, family size, gender, or other information associated with a user 204. Additionally, the personal information can include activity information of the user 204 associated with the social networking system 200. Further, the personal information can include information associated with one or more related users associated with the user 204.

As illustrated in FIG. 4, the method 400 further includes step 404, which may include identifying a purchase of a product by the user 204. For example, the purchase manager 104 of the system 100 can identify a purchase of a product by a user 204 and/or by a related user associated with the user 204. In some embodiments, identifying the purchase of the product can include identifying a purchase of the product through the social networking system 200. Additionally, identifying the purchase of the product can include identifying a purchase of the product through a third-party web site.

The method 400 further includes step 406, which may include generating a customized consumption interval for the product based on the personal information associated with the user 204. For example, the interval generator 106 of the system 100 can generate a customized consumption interval for the product in a variety of ways. In some embodiments, the customized consumption interval can include an estimated period of time in which the product will be consumed. Further, the customized consumption interval can correspond to consumption of the product by the user 204 and/or one or more related users associated with the user 204.

In some embodiments, generating the customize consumption interval can include identifying a default consumption interval based on the identified purchase of the product and modifying the default consumption interval based on the personal information associated with the user 204. As another example, in some embodiments, generating the customized consumption interval includes calculating the customized consumption interval using multiple types of personal information. Additionally, each type of personal information can modify the calculation of the customized consumption interval in a similar or different manner. In yet another example, in some embodiments, generating the customized consumption interval can include looking up a consumption interval value on a table that maps one or more types of personal information to one or more values associated with a consumption interval for a product.

As illustrated in FIG. 4, the method 400 further includes step 408, which may include remarketing the product to the user base on the customized consumption interval. For example, the marketing manager 108 of the system 100 can provide remarketing content to a user 204 based on the customized consumption interval. In some embodiments, remarketing a product to the user 204 can include providing remarketing content to the user 204 via the social networking system 200. Additionally, in some embodiments, the method 400 may further include remarketing a related product associated with the product based on the customized consumption interval.

In some embodiments, the method 400 can include fewer or additional steps. For example, the method 400 may include identifying a subsequent purchase related to the product by the user 204. Additionally, the method 400 may include modifying the customized consumption interval based on the identified subsequent purchase. Further, the method 400 can include remarketing the product to the user based on the modified customized consumption interval.

Furthermore, while not illustrated in FIG. 4, the method 400 can further include maintaining social networking profiles associated with a user 304a and a related user 304b associated with the user 304a. The social networking profiles can include personal information associated with the user 304a and the related user 304b. The method 400 can further include identifying a purchase of a product by the user 304a or the related user 304b. The method 400 can further include generating a customized consumption interval for the product based on the identified purchase of the product and the personal information associated with the user 304a and the related user 304b. The method 400 can further include remarketing the product to at least one of the user 304a or the related user 304b based on the customized consumption interval.

In some embodiments, the personal information associated with the user 304a can include an address of the user 304a. Additionally, the method 400 can include identifying that the related user 304b has the same address as the user 304a. Further, in some embodiments, the customized consumption interval can correspond to consumption of the product by the user 304a and the related user 304b based on identifying the related user 304b has the same address as the user 304a.

One or more embodiments may comprise or utilize a special purpose or general-purpose computer including computer hardware, such as, for example, one or more processors and system memory, as discussed in greater detail below. Embodiments may also include physical and other computer-readable media for carrying or storing computer-executable instructions and/or data structures. In certain particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, example embodiments can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of one or more embodiments. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the one or more embodiments may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. One or more embodiments may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Example embodiments can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 5 illustrates, in block diagram form, an exemplary computing device 500 that may be configured to perform one or more of the processes described above. One will appreciate that the system 100, client devices 202, 302, social networking systems 200, 300, and third-party servers 208, 308 can each comprise implementations of the data-computing device 500. As shown by FIG. 5, the computing device 500 can comprise a processor 502, memory 504, a storage device 506, an I/O interface 508, and a communication interface 510. While an exemplary computing device 500 is shown in FIG. 5, the components illustrated in FIG. 5 are not intended to be limiting. Additional or alternative components may be used in other embodiments. Furthermore, in certain embodiments, a computing device 500 can include fewer components than those shown in FIG. 5. Components of computing device 500 shown in FIG. 5 will now be described in additional detail.

In particular embodiments, processor(s) 502 includes hardware for executing instructions, such as those making up a computer program. As an example and not by way of limitation, to execute instructions, processor(s) 502 may retrieve (or fetch) the instructions from an internal register, an internal cache, memory 504, or a storage device 506 and decode and execute them. In particular embodiments, processor(s) 502 may include one or more internal caches for data, instructions, or addresses. As an example and not by way of limitation, processor(s) 502 may include one or more instruction caches, one or more data caches, and one or more translation lookaside buffers (TLBs). Instructions in the instruction caches may be copies of instructions in memory 504 or storage 506.

The computing device 500 includes memory 504, which is coupled to the processor(s) 502. The memory 504 may be used for storing data, metadata, and programs for execution by the processor(s) 502. The memory 504 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 504 may be internal or distributed memory.

The computing device 500 includes a storage device 506 includes storage for storing data or instructions. As an example and not by way of limitation, storage device 506 can comprise a non-transitory storage medium described above. The storage device 506 may include a hard disk drive (HDD), a floppy disk drive, flash memory, an optical disc, a magneto-optical disc, magnetic tape, or a Universal Serial Bus (USB) drive or a combination of two or more of these. Storage device 506 may include removable or non-removable (or fixed) media, where appropriate. Storage device 506 may be internal or external to the computing device 500. In particular embodiments, storage device 506 is non-volatile, solid-state memory. In particular embodiments, Storage device 506 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The computing device 500 also includes one or more input or output (“I/O”) devices/interfaces 508, which are provided to allow a user to provide input to, receive output from, and otherwise transfer data to and from the computing device 500. These I/O devices/interfaces 508 may include a mouse, keypad or a keyboard, a touch screen, camera, optical scanner, network interface, modem, other known I/O devices or a combination of such I/O devices/interfaces 508. The touch screen may be activated with a stylus or a finger.

The I/O devices/interfaces 508 may include one or more devices for presenting output to a user, including, but not limited to, a graphics engine, a display (e.g., a display screen), one or more output drivers (e.g., display drivers), one or more audio speakers, and one or more audio drivers. In certain embodiments, devices/interfaces 508 is configured to provide graphical data to a display for presentation to a user. The graphical data may be representative of one or more graphical user interfaces and/or any other graphical content as may serve a particular implementation.

The computing device 500 can further include a communication interface 510. The communication interface 510 can include hardware, software, or both. In any event, the communication interface 510 can provide one or more interfaces for communication (such as, for example, packet-based communication) between the computing device and one or more other computing devices 510 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI.

This disclosure contemplates any suitable network and any suitable communication interface 510. As an example and not by way of limitation, computing device 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computing device 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof. Computing device 500 may include any suitable communication interface 510 for any of these networks, where appropriate.

The computing device 500 can further include a bus 512. The bus 512 can comprise hardware, software, or both that couples components of computing device 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the system 100 and/or social networking systems 200, 300 can comprise a social-networking system. A social-networking system may enable its users (such as persons or organizations) to interact with the system and with each other. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users

The social-networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social-networking system. A user may be an individual (human user), an entity (e.g., an enterprise, business, or third-party application), or a group (e.g., of individuals or entities). A user node corresponding to a user may comprise information provided by the user and information gathered by various systems, including the social-networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social-networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social-networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social-networking system to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social-networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social-networking system may construct a web page (or a structured document) of a concept node (e.g., a restaurant, a celebrity), incorporating one or more selectable buttons (e.g., “like”, “check in”) in the web page. A user can access the page using a web browser hosted by the user's client device and select a selectable button, causing the client device to transmit to the social-networking system a request to create an edge between a user node of the user and a concept node of the concept, indicating a relationship between the user and the concept (e.g., the user checks in a restaurant, or the user “likes” a celebrity).

As an example, a user may provide (or change) his or her city of residence, causing the social-networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social-networking system may support a variety of applications, such as photo sharing, on-line calendars and events, gaming, instant messaging, and advertising. For example, the social-networking system may also include media sharing capabilities. Also, the social-networking system may allow users to post photographs and other multimedia files to a user's profile page (typically known as “wall posts” or “timeline posts”) or in a photo album, both of which may be accessible to other users of the social-networking system depending upon the user's configured privacy settings. The social-networking system may also allow users to configure events. For example, a first user may configure an event with attributes including time and date of the event, location of the event and other users invited to the event. The invited users may receive invitations to the event and respond (such as by accepting the invitation or declining it). Furthermore, the social-networking system may allow users to maintain a personal calendar. Similarly to events, the calendar entries may include times, dates, locations and identities of other users.

FIG. 6 illustrates an example network environment of a social-networking system. In particular embodiments, a social-networking system 602 may comprise one or more data stores. In particular embodiments, the social-networking system 602 may store a social graph comprising user nodes, concept nodes, and edges between nodes as described earlier. Each user node may comprise one or more data objects corresponding to information associated with or describing a user. Each concept node may comprise one or more data objects corresponding to information associated with a concept. Each edge between a pair of nodes may comprise one or more data objects corresponding to information associated with a relationship between users (or between a user and a concept, or between concepts) corresponding to the pair of nodes.

In particular embodiments, the social-networking system 602 may comprise one or more computing devices (e.g., servers) hosting functionality directed to operation of the social-networking system 602. A user of the social-networking system 602 may access the social-networking system 602 using a client device such as client device 606. In particular embodiments, the client device 606 can interact with the social-networking system 602 through a network 604.

The client device 606 may be a desktop computer, laptop computer, tablet computer, personal digital assistant (PDA), in- or out-of-car navigation system, smart phone or other cellular or mobile phone, or mobile gaming device, other mobile device, or other suitable computing devices. Client device 606 may execute one or more client applications, such as a web browser (e.g., Microsoft Windows Internet Explorer, Mozilla Firefox, Apple Safari, Google Chrome, Opera, etc.) or a native or special-purpose client application (e.g., Facebook for iPhone or iPad, Facebook for Android, etc.), to access and view content over a network 604.

Network 604 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 606 may access the social-networking system 602.

While these methods, systems, and user interfaces utilize both publicly available information as well as information provided by users of the social-networking system, all use of such information is to be explicitly subject to all privacy settings of the involved users and the privacy policy of the social-networking system as a whole.

In the foregoing specification, one or more embodiments have been described with reference to specific exemplary embodiments thereof. Various embodiments are described with reference to details discussed herein, and the accompanying drawings illustrate the various embodiments. The description above and drawings are illustrative of one or more examples, and are not to be construed as limiting. Numerous specific details are described to provide a thorough understanding of various embodiments.

One or more embodiments may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the disclosure is, therefore, indicated by the appended claims rather than by the foregoing description. All changes that come within the meaning and range of equivalency of the claims are to be embraced within their scope.

What is claimed is:

1. A method comprising:
maintaining, using at least one processor, a social networking profile associated with a user of a social networking system, the social networking profile comprising personal information associated with the user;
identifying a purchase of a product by the user;
generating a customized consumption interval for the product based on the personal information in the social networking profile associated with the user;
remarketing the product or another product to the user based on the customized consumption interval.

2. The method of claim 1, wherein the personal information comprises one or more of a location, an age, a family size, or a gender associated with the user.

3. The method of claim 1, further comprising:
identifying one or more related users associated with the user;
identifying personal information associated with the one or more related users; and
generating the customized consumption interval based, at least in part, on the personal information associated with the one or more related users.

4. The method of claim 1, wherein generating the customized consumption interval is further based on social networking information associated with the user of the social networking system.

5. The method of claim 1, wherein identifying a purchase of the product comprises identifying a purchase of the product through the social networking system.

6. The method of claim 1, wherein identifying a purchase of the product comprises identifying a purchase of the product through a third-party web site.

7. The method of claim 1, wherein the customized consumption interval comprises an estimated period of time in which the product will be consumed.

8. The method of claim 1, wherein the customized consumption interval corresponds to consumption of the product by the user.

9. The method of claim 1, wherein the customized consumption interval corresponds to consumption of the product by the user and one or more related users associated with the user.

10. The method of claim 1, wherein generating a customized consumption interval comprises:
identifying a default consumption interval based on the identified purchase of the product; and
modifying the default consumption interval based on the personal information associated with the user.

11. The method of claim 1, wherein generating a customized consumption interval comprises calculating the customized consumption interval using multiple types of personal information associated with the user, and wherein each of the multiple types of personal information results in a corresponding modification of the customized consumption interval.

12. The method of claim 1, wherein generating a customized consumption interval comprises looking up a consumption interval value on a table that maps personal information to one or more values associated with a consumption interval for the product.

13. The method of claim 1, wherein remarketing the product or another product to the user comprises providing remarketing content to the user via the social networking system.

14. The method of claim 1, wherein remarketing the product or another product to the user comprises remarketing a product related to the product.

15. The method of claim 1, further comprising:
identifying a subsequent purchase related to the product by the user;
modifying the customized consumption interval based on the identified subsequent purchase; and
remarketing the product or another product to the user based on the modified customized consumption interval.

16. A method comprising:
maintaining, using at least one processor, social networking profiles associated with a user and a related user associated with the user of a social networking system, the social networking profiles comprising personal information associated with the user and the related user;
identifying a purchase of a product by the user or by the related user;
generating a customized consumption interval for the product based on the identified purchase of the product and the personal information associated with the user and the related user; and
remarketing the product or another product to at least one of the user or the related user based on the customized consumption interval.

17. The method of claim 16, wherein the personal information associated with the user or the related user comprises at least one of a gender, an age, or an address of the user or the related user.

18. The method of claim 16, further comprising determining that that the related user has the same address as the user.

19. The method of claim 18, wherein the customized consumption interval corresponds to consumption of the product by the user and the related user based on the determination that the related user has the same address as the user.

20. A system comprising:
at least one processor; and
at least one non-transitory computer readable storage medium storing instructions thereon that, when executed by the at least one processor, cause the system to:
maintain a social networking profile associated with a user of a social networking system, the social networking profile comprising personal information associated with the user;
identify a purchase of a product by the user;
generate a customized consumption interval for the product based on the personal information associated with the user; and
remarket the product or another product to the user based on the customized consumption interval.
